(19) United States
(12) Patent Application Publication
(10) Pub. No.: US 2023/0276343 A1
(43) Pub. Date: Aug. 31, 2023

(54) TRACKING AREA CODE-BASED CELL BARRING IN NTN

(71) Applicant: QUALCOMM Incorporated, San Diego, CA (US)

(72) Inventors: Bharat SHRESTHA, San Diego, CA (US); Umesh PHUYAL, San Diego, CA (US); Mungal Singh DHANDA, Slough (GB)

(21) Appl. No.: 18/166,434

(22) Filed: Feb. 8, 2023

Related U.S. Application Data
(60) Provisional application No. 63/268,693, filed on Feb. 28, 2022.

(51) Int. Cl. H04W 48/04; H04W 48/08; H04W 36/00

(52) U.S. Cl. CPC H04W 48/04; H04W 48/08; H04W 36/0061; H04W 88/10

(57) ABSTRACT

Apparatus, methods, and computer program products for tracking area code (TAC) based cell barring. An example method at a user equipment (UE) may include receiving, from at least one cell, a system information block (SIB) comprising a tracking area list associated with a non-terrestrial network (NTN) and the at least one cell, the SIB not including a tracking area code associated with a terrestrial network (TN) or the NTN, a supported network of the UE corresponding to the TN. The example method may further include skipping, based on the tracking area code being absent and the tracking area list being present or both the tracking area code and the tracking area list being absent in the SIB, a selection of the at least one cell for subsequent communication.

### CROSS REFERENCE TO RELATED APPLICATION(S)

This application claims the benefit of and priority to U.S. Provisional Application Ser. No. 63/268,693, entitled “TRACKING AREA CODE-BASED CELL BARRING IN NTN” and filed on Feb. 28, 2022, which is expressly incorporated by reference herein in its entirety.

### TECHNICAL FIELD

The present disclosure relates generally to communication systems, and more particularly, to wireless communication systems with tracking area code (TAC).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from at least one cell, a system information block (SIB) including a tracking area code or a tracking area list, the tracking area list being associated with a non-terrestrial network (NTN) and the at least one cell, the tracking area code being associated with a terrestrial network (TN) or the NTN. The memory and the at least one processor coupled to the memory may be further configured to skip, based on the tracking area code being absent and the tracking area list being present or both the tracking area code and the tracking area list being absent in the SIB, a selection of the at least one cell for subsequent communication.

In another aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from at least one cell, a system information block (SIB) including a tracking area list associated with a non-terrestrial network (NTN) and the at least one cell, the SIB not including a tracking area code associated with a terrestrial network (TN) or the NTN, a supported network of the UE corresponding to the NTN. The memory and the at least one processor coupled to the memory may be further configured to select, based on the tracking area list in the SIB, the at least one cell for subsequent communication.

In another aspect of the disclosure, a method, a computer-readable medium, and an apparatus at a network entity are provided. The apparatus may include a memory and at least one processor coupled to the memory. The memory and the at least one processor coupled to the memory may be configured to transmit a system information block (SIB) associated with the at least one cell, the SIB including a tracking area list associated with a non-terrestrial network (NTN) and the at least one cell, the SIB not including a tracking area code associated with a terrestrial network (TN) or the NTN. The memory and the at least one processor coupled to the memory may be further configured to communicate with at least one UE supporting the NTN via the at least one cell.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example environment.

FIG. 5 illustrates a communication flow of a wireless communication system.

FIG. 6 is a flowchart of a method of wireless communication.

FIG. 7 is a flowchart of a method of wireless communication.

FIG. 8 is a flowchart of a method of wireless communication.

FIG. 9 is a diagram illustrating an example of a hardware implementation for an example apparatus and/or network entity.

FIG. 10 is a diagram illustrating an example of a hardware implementation for an example apparatus and/or network entity.

FIG. 11 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR B S, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

It may be advantageous to inform the UE whether the network is a TN or an NTN no later than the reception of a SIB 1. The TN cells and the NTN cells may be deployed in the same band over a same geographical area, and absent additional indications, a UE may detect and camp on a cell that is not suitable for the UE. For example, a UE that is expected to communicate with and camp on a TN cell and does not support an NTN cell (which may be referred to herein as a TN-supporting UE) may inappropriately detect and camp on an NTN cell. This may occur as existing TN-supporting UEs may not understand some fields or parameters (e.g., the satellite specific parameters) in the MIB or the SIB, and may ignore the fields or parameters and camp inappropriately on the NTN cell. Similarly, a UE that is expected to communicate with and camp on an NTN cell (which may be referred to herein as an NTN-supporting UE) may inappropriately detect and camp on a TN cell. Therefore, it may be beneficial for an NTN cell to bar TN-supporting UEs but not NTN-supporting UEs, and for a TN cell to bar NTN-supporting UEs but not TN-supporting UEs. Aspects provided herein provide mechanisms to bar NTN supporting UEs.

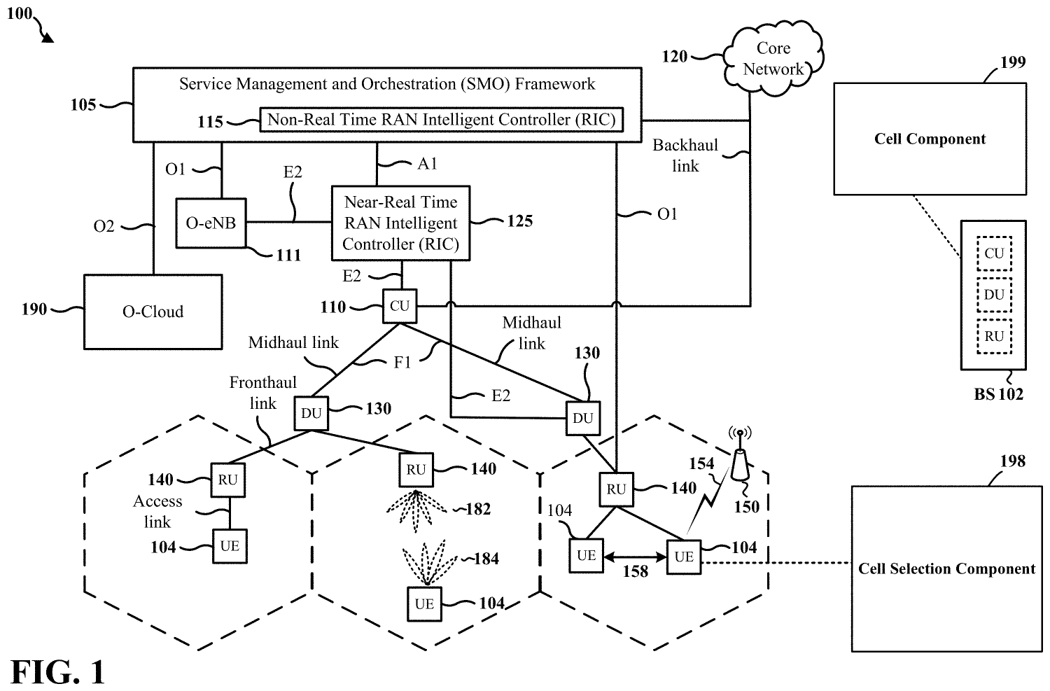

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (MC) 125 via an E2 link, or a Non-Real Time (Non-RT) MC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a cell selection component 198. In some aspects, the cell selection component 198 may be configured to receive, from at least one cell, a system information block (SIB) including a tracking area code or a tracking area list, the tracking area list being associated with a non-terrestrial network (NTN) and the at least one cell, the tracking area code being associated with a terrestrial network (TN) or the NTN. In some aspects, the cell selection component 198 may be further configured to skip, based on the tracking area code being absent and the tracking area list being present or both the tracking area code and the tracking area list being absent in the SIB, a selection of the at least one cell for subsequent communication. In some aspects, the cell selection component 198 may be configured to receive, from at least one cell, a system information block (SIB) including a tracking area list associated with a non-terrestrial network (NTN) and the at least one cell, the SIB not including a tracking area code associated with a terrestrial network (TN) or the NTN, a supported network of the UE corresponding to the NTN. In some aspects, the cell selection component 198 may be further configured to select, based on the tracking area list in the SIB, the at least one cell for subsequent communication.

In certain aspects, the base station 102 may include a cell component 199. In some aspects, the cell component 199 may be configured to transmit a system information block (SIB) associated with the at least one cell, the SIB including a tracking area list associated with a non-terrestrial network (NTN) and the at least one cell, the SIB not including a tracking area code associated with a terrestrial network (TN) or the NTN. In some aspects, the cell component 199 may be further configured to communicate with at least one UE supporting the NTN via the at least one cell.

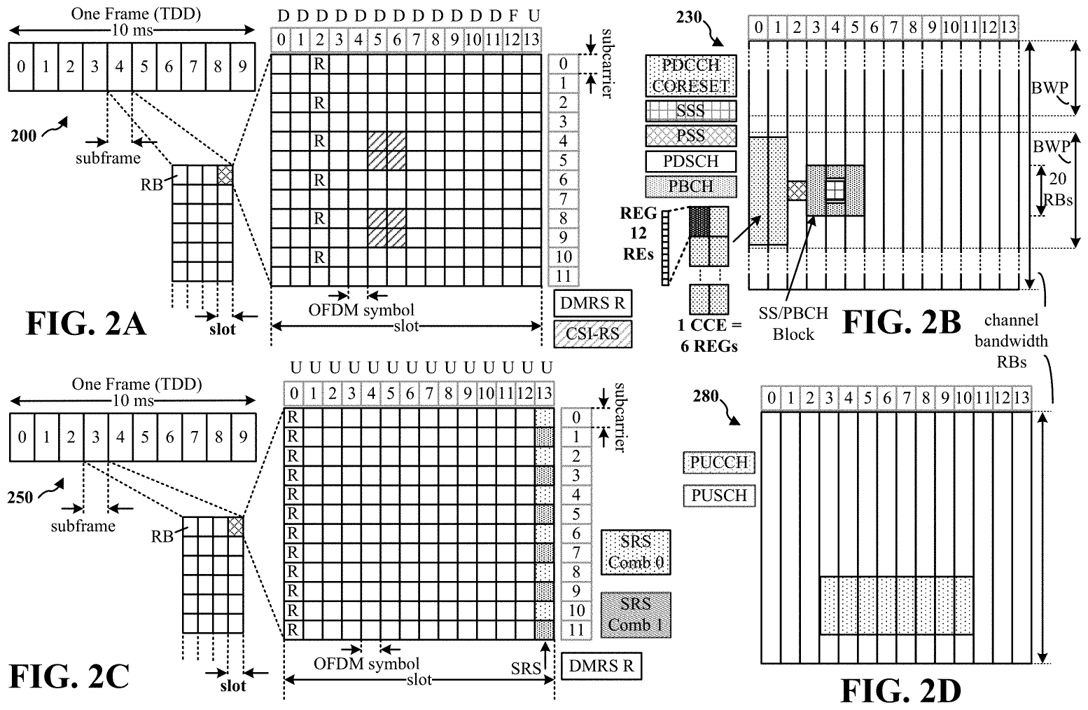

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

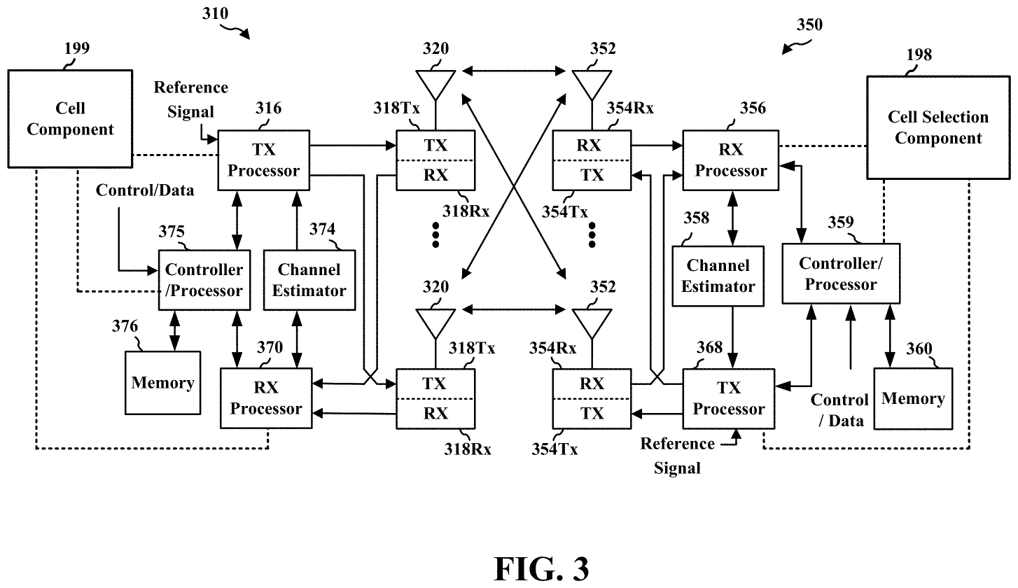

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with cell selection component 198 of FIG. 1.

At least one of the TX processor 316, the RX processor 370, and the controller/processor 375 may be configured to perform aspects in connection with cell component 199 of FIG. 1.

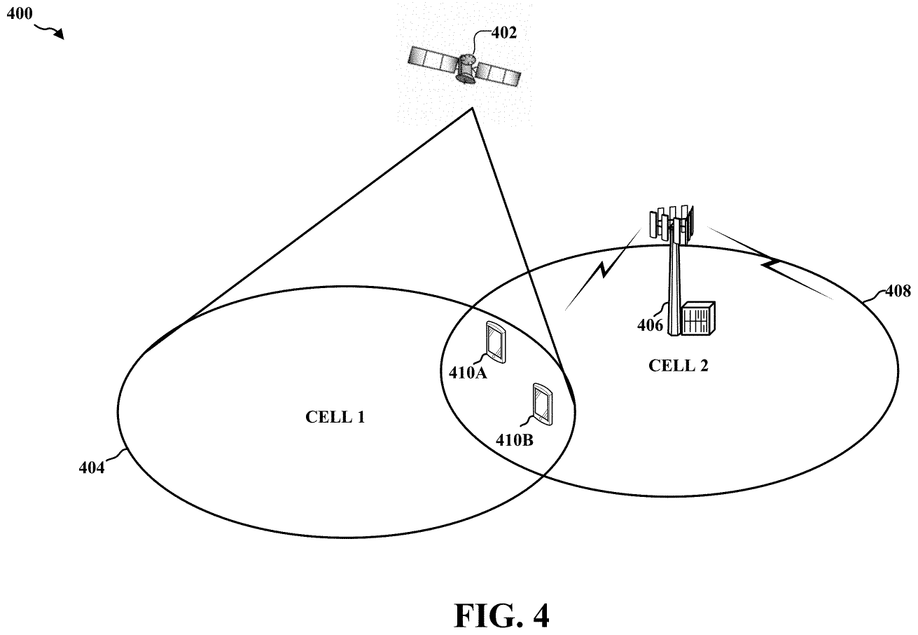

FIG. 4 is a diagram illustrating an example environment 400. In an NTN, an NTN cell, such as the first cell 404, may be enabled by a communication satellite, such as the communication satellite/space vehicle 402. A TN cell (e.g., the second cell 408) may be enabled by a terrestrial base station (e.g., the base station 406). The space vehicle enabling the NTN cell may be one of a high altitude pseudo-satellite (HAPS), a low earth orbit (LEO) satellite, a medium earth orbit (MEO) satellite, or a geostationary (GEO) satellite. An NTN cell may be a moving cell that may move as the space vehicle moves across the sky. Alternatively, the space vehicle may steer the transmit and receive beams as the space vehicle moves across the sky such that the NTN cell enabled on and near the surface of the earth is fixed relative to the earth. A fixed NTN cell may also be enabled by a GEO satellite.

It may be advantageous to inform the UE whether the network is a TN or an NTN no later than the reception of a SIB1. A SIB1 may be a SIB that includes cell-specific information valid for serving cell and may provide information for the UE to access the cell. A SIB1 may also be referred to as “remaining minimum system information (RMSI).” A SIB2 may carry information common to intra-frequency for a cell. The SIBs other than SIB1 and SIB2 may include Information about the serving frequency and intra-frequency neighboring cells relevant for cell re-selection (including cell re-selection parameters common for a frequency as well as cell specific re-selection parameters), Information about other frequencies and inter-frequency neighboring cells relevant for cell re-selection (including cell re-selection parameters common for a frequency as well as cell specific re-selection parameters), or notifications.

The TN cells and the NTN cells may be deployed in the same band over a same geographical area, and absent additional indications, a UE 410A, 410B may detect and camp on a cell that is not suitable for the UE. For example, a UE 410A that is expected to communicate with and camp on a TN cell and does not support an NTN cell (which may be referred to herein as a TN-supporting UE) may inappropriately detect and camp on an NTN cell. This may occur as existing TN-supporting UEs may not understand NTN related fields or parameters (e.g., the satellite specific parameters) in the MIB or the SIB, and may ignore the fields or parameters and camp inappropriately on the NTN cell. Similarly, a UE 410B that is expected to communicate with and camp on an NTN cell (which may be referred to herein as an NTN-supporting UE) may inappropriately detect and camp on a TN cell. Therefore, it may be beneficial for an NTN cell to bar TN-supporting UEs but not NTN-supporting UEs, and for a TN cell to bar NTN-supporting UEs but not TN-supporting UEs.

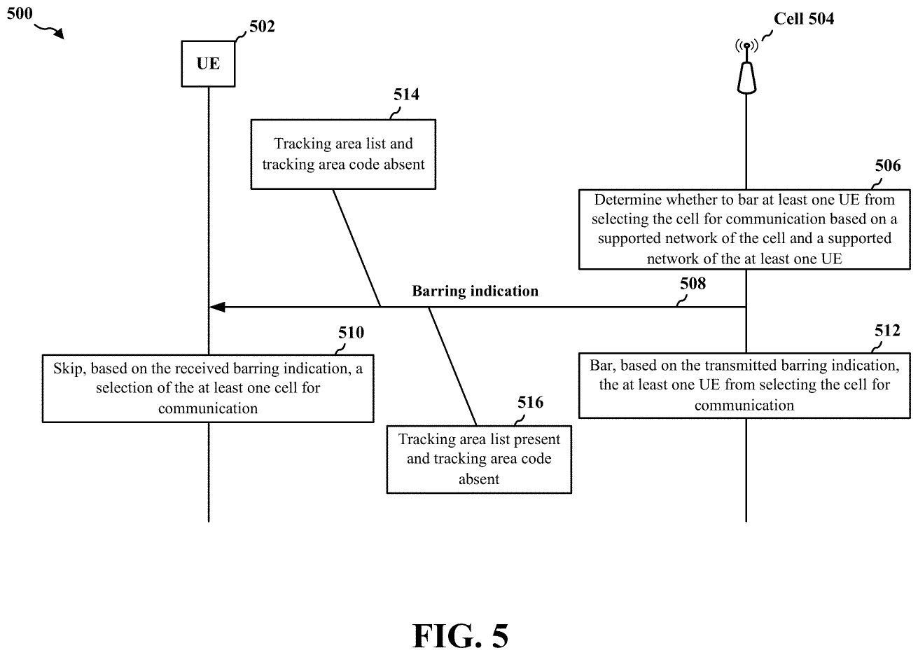

FIG. 5 illustrates a communication flow 500 of a wireless communication system. At 506, the cell 504 may determine whether to bar at least one UE 502 from selecting the cell 504 for communication based on a supported network of the cell 504 and a supported network of the at least one UE 502. The supported network of the cell may correspond to a TN or an NTN, and the supported network of the at least one UE may correspond to a TN or an NTN.

At 508, the cell 504 may transmit to the at least one UE 502, and the UE 502 may receive, from at least one cell 504, via at least one bit in a MIB or SIB, a barring indication based on the supported network of the cell 504 and the supported network of the at least one UE 502. In some aspects, the barring indication may be based on a SIB, such as a SIB 1 that includes a tracking area list associated with the at least one cell and does not include a tracking area code associated with the at least one cell (e.g., as shown in 516). In some aspects, the barring indication may be based on a SIB, such as a SIB 1 that does not include a tracking area list associated with the at least one cell or a tracking area code associated with the at least one cell (e.g., as shown in 514). A tracking area code may be an identifier of a location in a wireless communication network. As an example, the tracking code may include a hexadecimal value for identifying a location in a cellular radio network. A location may include one or more radio cells and each location may be associated with a tracking area code, which serves as an identifier for the location and the one or more radio cells. A tracking area list may be a sequence of tracking area codes associated with a public land mobile network (PLMN).

At 510, the UE 502 may skip, based on the received barring indication, a selection of the at least one cell 504 for communication. At 512, the cell 504 may bar, based on the transmitted barring indication, the at least one UE 502 from selecting the cell 504 for communication.

In one configuration, the communication may correspond to the at least one UE 502 camping on the cell 504. Therefore, once barred from the cell 504, the UE 502 may not camp on the cell 504.

In one configuration, the at least one UE 502 may be barred from selecting the cell 504 for communication for a time period (e.g., 300 s). This may be useful for a temporary barring of NTN access. The bar may end after the time period expires, and the UE 502 may then consider the cell 504 for cell reselection. When a LEO satellite enabled cell 504 is barred for NTN access, a shorter barring duration (e.g., <300 s) may be used based on the cell visibility duration (e.g., the cell size) or the satellite revisit time.

In one configuration, the at least one UE may be barred from selecting the cell for communication for a duration of the UE storing information about barring access to the cell, and the information about barring access to the cell includes at least one of a physical cell identifier (PCID) or a frequency of the cell. Thus, if the cell 504 is barred for NTN-supporting UEs (e.g., UE 502) for NTN access, the cell 504 is accessible to TN-supporting UEs (e.g., UE 502) but not to NTN-supporting UEs (e.g., UE 502). Conversely, if the cell 504 is barred for TN-supporting UEs (e.g., UE 502) for TN access, the cell 504 is accessible to NTN-supporting UEs (e.g., UE 502) but not to TN-supporting UEs (e.g., UE 502).

In one configuration, a TN-supporting UE of the at least one UE may be barred from selecting the cell for communication when the cell is an NTN-supporting cell, and an NTN-supporting UE of the at least one UE may be barred from selecting the cell for communication when the cell is a TN-supporting cell.

In one configuration, NTN-supporting UEs may ignore a barring indication in the MIB (e.g., the first barring indication in the MIB, the “cellBarred” parameter in the MIB), and TN-supporting UEs may follow the barring indication in the MIB (e.g., the first barring indication in the MIB) as normal. A spare bit in the MIB may be used to introduce a new NTN-specific barring indication (e.g., the second barring indication in the MIB) that may be applicable to NTN-supporting UEs or NTN access but not to TN-supporting UEs. Therefore, whether NTN access is barred for NTN-supporting UEs may be based on the new NTN-specific barring indication (e.g., the second barring indication in the MIB). In particular, for example, if the second barring indication in the MIB is set to 0, NTN-supporting UEs may be barred (including in a cell with a conventional TN base station). If the second barring indication in the MIB is set to 1, NTN access by NTN-supporting UEs may be allowed. In another example, the bit definition of the second barring indication in the MIB may be reversed. The TN-supporting UEs in the TN access mode may still use the barring indication in the MIB and may ignore the new NTN-specific barring indication in the MIB. Accordingly, a UE (whether a TN-supporting UE or an NTN-supporting UE) may learn the cell type (e.g., whether the cell is barred or allowed) from the MIB without acquiring the SIB1, and power may be saved. This configuration may be applicable to NR. Accordingly, a TN-supporting UE (e.g., UE 502) may be barred or not barred from selecting the cell 504 for communication based on a first barring indication in the MIB regardless of a second barring indication in the MIB, and an NTN-supporting UE (e.g., UE 502) may be barred or not barred from selecting the cell 504 for communication based on the second barring indication in the MIB regardless of the first barring indication in the MIB.

In one configuration, a reserved bit in the MIB may be used to introduce a cell type indication. In another configuration, an existing bit in the MIB may be repurposed to introduce the cell type indication. For example, a bit value of 0 at the cell type indication may indicate a TN cell type, and bit value of 1 may indicate an NTN cell type. In another example, the bit definition of the cell type indication may be reversed. An indication of a TN cell type may bar NTN-supporting UEs from access. The existing barring indication in the SIB1 (e.g., the third barring indication in the SIB1, the “Unified Access Barring (UAC)-Barring Information” in the SIB1) may be used as normal by NTN-supporting UEs (and by TN-supporting UEs). This configuration may be applicable to enhanced machine type communication (eMTC) or narrowband (NB)-internet of things (IoT) (NB-IoT). Accordingly, the MIB may include a cell type indication indicative of the cell 504 as being either a TN-supporting cell or an NTN-supporting cell, and an NTN-supporting UE (e.g., UE 502) may be barred or not barred from selecting the cell for communication based on the cell type indication and a third barring indication in a SIB 1. The NTN-supporting UE (e.g., UE 502) may be barred from selecting the cell 504 for communication based on the cell type indication indicative of the cell as being a TN-supporting cell.

In one configuration, a reserved bit in the MIB may be used to introduce a new barring indication (e.g., a fourth barring indication in the MIB). For example, a bit value of 0 at the fourth barring indication may indicate the cell is barred (e.g., existing or eNB TN type cell may bar NTN-supporting UEs), and a bit value of 1 may indicate the cell is not barred. In another example, the bit definition of the fourth barring indication may be reversed. The existing barring indication in the SIB1 (e.g., the third barring indication in the SIB1; the “Unified Access Barring (UAC)-Barring Information” in the SIB1) may be used by TN-supporting UEs or existing UEs but not by NTN-supporting UEs (e.g., the NTN-supporting UEs may ignore the existing barring indication in the SIB1). This configuration may be applicable to eMTC or NB-IoT. Accordingly, a TN-supporting UE (e.g., UE 502) may be barred or not barred from selecting the cell 504 for communication based on a third barring indication in a SIB1 regardless of a fourth barring indication in the MIB, and an NTN-supporting UE (e.g., UE 502) may be barred or not barred from selecting the cell 504 for communication based on the fourth barring indication in the MIB regardless of the third barring indication in the SIB 1.

In one configuration, for eMTC, the “phich-Config” parameter in the MIB may be repurposed for indicating a cell type or a cell barring indication. In one configuration, for eMTC, a whole MIB (e.g., the MasterInformationBlock-MBMS-r14 block) may be repurposed for the NTN access. The phich-Config may be a parameter that provides the configuration of the physical HARQ indication channel (PHICH), which may include PHICH durations (e.g., in time) (e.g., for different cyclic prefixes) and PHICH resources.

In one configuration, the barring indication in the MIB (e.g., the first barring indication in the MIB, the “cellBarred” parameter in the MIB) may be applicable to NTN-supporting UEs for NTN access. The first barring indication in the MIB may be applicable to all UEs, both TN-supporting and NTN-supporting. In addition, if the “ssb-SubcarrierOffset” parameter in the MIB indicates that this cell does not provide a SIB1, the indication may mean that the cell is barred for NTN access (but not for TN access) even if the existing barring indication (e.g., the first barring indication in the MIB, the “cellBarred” parameter in the MIB) does not indicate a bar. In some aspects, ssb-SubcarrierOffset may be a parameter that provides frequency domain offset between SSB and an overall resource block grid in number of subcarriers. An absence of the parameter ssb-SubcarrierOffset may be interpreted as a frequency domain offset between SSB and an overall resource block grid of zero subcarriers. Alternatively, if the MIB is not associated with an SSB, then the cell may be considered barred for NTN access. This configuration may be applicable to NR. Accordingly, a TN-supporting UE (e.g., UE 502) may be barred or not barred from selecting the cell 504 for communication based on a first barring indication in the MIB, and an NTN-supporting UE (e.g., UE 502) may be barred or not barred from selecting the cell 504 for communication based on the first barring indication in the MIB and at least one additional indication in the MIB. The NTN-supporting UE (e.g., UE 502) may be barred from selecting the cell 504 for communication based on the first barring indication in the MIB indicative of a bar or the at least one additional indication in the MIB indicative of an absence of a SIB1 in the cell 504.

In one configuration, one or more parameters may be used together to determine whether the cell is barred or not barred for NTN-supporting UEs. The “cellBarred” parameter in the MIB (e.g., the first barring indication in the MIB) alone may not be sufficient to bar NTN-supporting UEs for NTN access. NT-supporting UEs may follow the “cellBarred” parameter in the MIB (e.g., the first barring indication in the MIB) as normal. NTN-supporting UEs may not be barred when the “cellBarred” parameter in the MIB (e.g., the first barring indication in the MIB) does not indicate a bar. Further, one or more additional parameters, e.g., a spare bit, the “intraFreqReselection” parameter, the “pdcch-ConfigSIB1” parameter, or the “ssb-SubcarrierOffset” parameter in the MIB may be used to indicate whether NTN-supporting UEs are barred when the “cellBarred” parameter in the MIB (e.g., the first barring indication in the MIB) does indicate a bar. For example, the “cellBarred” parameter may indicate a bar and the field “ssb-SubcarrierOffset” may indicate that the SIB1 is absent, then NTN-supporting UEs may be barred from accessing the cell. In another example, when the “cellBarred” parameter indicate a bar, whether NTN-supporting UEs are barred or allowed may be based on the value of a separate indication introduced using a spare bit in the MIB. In some aspects, the intraFreqReselection may be a parameter that indicates whether the UE may select another cell on the same frequency (if reselection criteria are fulfilled). For example, NTN-supporting UEs may be barred when the separate indication is set to 0, and may be allowed when the separate indication is set to 1. In another example, the bit definition of the separate indication in the MIB may be reversed. If an NTN-supporting UE finds both an NTN cell and a TN cell, the NTN-supporting UE may prioritize the selection of the TN cell over the NTN cell. If a TN cell (e.g., an existing cell) indicates cell barring via the “cellBarred” parameter in the MIB (e.g., the first barring indication in the MIB), then the TN cell may not be barred for all UEs (TN-supporting UEs and NTN-supporting UEs) (e.g., TN-supporting UEs may be barred, whereas NTN-supporting UEs may be allowed). In other words, a TN cell may not selectively bar TN-supporting UEs or NTN-supporting UEs, but an NTN cell may selectively bar TN-supporting UEs or NTN-supporting UEs. This configuration may be applicable to NR. Accordingly, a TN-supporting UE (e.g., UE 502) may be barred or not barred from selecting the cell 504 for communication based on a first barring indication in the MIB, and an NTN-supporting UE (e.g., UE 502) may be barred or not barred from selecting the cell 504 for communication based on at least one additional indication in the MIB when the first barring indication in the MIB indicates a bar. The NTN-supporting UE (e.g., UE 502) may not be barred from selecting the cell 504 for communication when the first barring indication in the MIB does not indicate a bar. The NTN-supporting UE (e.g., UE 502) may be barred from selecting the cell 504 for communication based on the at least one additional indication in the MIB indicative of a bar of NTN-supporting UEs when the first barring indication in the MIB indicates a bar.

In one configuration, the barring indication in MIB (e.g., the first barring indication in the MIB, the “cellBarred” parameter in the MIB) may be ignored by NTN-supporting UEs for NTN access. In other words, the first barring indication in the MIB may be applicable to TN access by TN-supporting UEs. If the SIB1 does not schedule a new NTN specific SIB, or does not schedule a SIB that provides satellite specific information (e.g., ephemeris), the cell may be barred for NTN-supporting UEs or NTN access. Accordingly, a TN-supporting UE (e.g., UE 502) may be barred or not barred from selecting the cell 504 for communication based on a first barring indication in the MIB, and an NTN-supporting UE (e.g., UE 502) may be barred or not barred from selecting the cell 504 for communication based on a SIB1 regardless of the first barring indication in the MIB. The NTN-supporting UE (e.g., UE 502) may be barred from selecting the cell 504 for communication based on the SIB1 not scheduling at least one additional SIB including NTN-related information regardless of the first barring indication in the MIB.

In one configuration, the barring indication in MIB (e.g., the first barring indication in the MIB, the “cellBarred” parameter in the MIB) may be ignored by NTN-supporting UEs for NTN access. At least one indication in the SIB1, such as the “cellReservedForOperatorUse” parameter, the “cellReservedForOtherUse” parameter, or the “cellReservedForFutureUse” parameter indicated in the SIB1 may be used for barring the NTN-supporting UEs for NTN access. Accordingly, the NTN-supporting UE (e.g., UE 502) may be barred or not barred from selecting the cell 504 for communication based on an indication in the SIB1 regardless of the first barring indication in the MIB.

In one configuration, a TN-supporting UE (e.g., UE 502) may be barred or not barred from selecting the cell 504 for communication based on a first barring indication in the MIB, and based further on the indication in the SIB1 (e.g., “cellReservedForOperatorUse” parameter, the “cellReservedForOtherUse” parameter, or the “cellReservedForFutureUse” parameter).

In one configuration, a new barring indication (e.g., a fifth barring indication in the SIB1) for NTN-supporting UEs for NTN access may be introduced in the SIB1. Accordingly, an NTN-supporting UE (e.g., UE 502) may be barred or not barred from selecting the cell 504 for communication based on the fifth barring indication in the SIB1. The fifth barring indication in the SIB1 may be indicative of whether at least one of NTN LEO access or NTN GEO access is barred.

In one configuration, the existing cell barring indication, the “cellBarred” parameter in the SIB1 (e.g., the third barring indication in the SIB1) may be ignored by NTN-supporting UEs. A new barring indication (e.g., a fifth barring indication in the SIB1) for NTN-supporting UEs for NTN access may be introduced in the SIB1 (e.g., a “cellBarredNTN-r1xa” parameter in the SIB1). This configuration may be applicable to eMTC or NB-IoT. Accordingly, a TN-supporting UE (e.g., UE 502) may be barred or not barred from selecting the cell 504 for communication based on a third barring indication in a SIB1 regardless of a fifth barring indication in the SIB1, and an NTN-supporting UE (e.g., UE 502) may be barred or not barred from selecting the cell 504 for communication based on the fifth barring indication in the SIB1 regardless of the third barring indication in the SIB 1.

As provided herein, cell barring procedures may be based on a MIB enhancement, a barring indication bit in SIB 1, or repurpose fields like cellReservedForOperatorUse, cellReservedForOtherUse, or cellReservedForFutureUse. In some aspects, a new bit, e.g., cellBarred-NTN, may be introduced in SIB1 to bar NTN UEs from accessing an NTN cell. A UE for NB-IoT may consider or not consider the MIB instead of SIB 1. An NTN UE may ignore other bits for cell barring for TN UEs. Various aspects herein may provide mechanisms to prevent non-NTN capable UEs from accessing an NTN cell.

In some aspects, a mechanism or barring mechanism based on a tracking are code signaled in a SIB, such as SIB1, may be provided. In some aspects, in an NTN cell, a trackingAreaCode parameter may be absent for each PLMN which can be indication of cell barring to TN UEs. For NTNs, a list of trackingAreaCode per PLMN (e.g., which may be represented by a tracking area list parameter trackingArealist) may be used for both a hard TAC update and a soft TAC update mechanism. For a hard TAC update, the size of trackingAreaList may be one, e.g., including just one TAC, or a different type of trackingAreaCode per PLMN may be introduced. In some aspects, a tracking area code field (trackingAreaCode) may include a tracking area code to which the cell indicated by a cellIdentity field belongs. In some aspects, for NTN UEs, the absence of the trackingAreaList field may indicate that the cell supports PSCell/SCell functionality (per PLMN) without supporting other functionalities. In some other aspects for NTN UEs, the trackingAreaList field may not be present in a non-terrestrial network which can be indication of cell barring to NTN UEs.

In some aspects, a tracking area list field (trackingAreaList) may be a list of tracking areas to which the cell indicated by cellIdentity field belongs. If the field is present, the trackingAreaCode field may not be present. The total number of TACs across different PLMNs of the cell may not exceed a maximum TAC (maxTAC). The absence of the trackingAreaList field may indicate that the cell supports PSCell/SCell functionality (per PLMN) without supporting other functionalities.

In some aspects, upon reception of a SIB 1, if a frequencyShift7p5 khz parameter is present and the UE supports a corresponding 7.5 kHz frequency shift on the band, or if frequencyShift7p5 khz is not present, and if trackingAreaCode and trackingAreaList are not provided for the selected PLMN or the registered PLMN or PLMN of the equivalent PLMN list, the UE may consider the cell as barred or perform a cell re-selection to other cells on the same frequency as the barred cell. In some aspects, upon reception of SIB1, if frequencyShift7p5 khz is present and the UE supports a corresponding 7.5 kHz frequency shift on this band, or if frequencyShift7p5 khz is not present, if trackingAreaCode is not provided, and for a non-terrestrial network cell trackingAreaList not being provided, for the selected PLMN or the registered PLMN or PLMN of the equivalent PLMN list, the UE may consider the cell as barred or perform a cell re-selection to other cells on the same frequency as the barred cell.

In some aspects, an intraFreqReselection field may control cell selection/reselection to intra-frequency cells when the highest ranked cell is barred, or treated as barred by the UE. In some aspects, if a barring bit is introduced in SIB1, the UE may still follow what is indicated by intraFreqReselection in the MIB. In some aspects, another bit to control the cell selection/reselection to intra-frequency cells may be introduced in SIB1 and intraFreqReselection in the MIB may be ignored. In some aspects, if the tracking area code is used to bar UEs, such as TN UEs that do not support NTN, a network entity may control the TN UEs that do not support NTN by using a bit to control the cell selection/reselection to intra-frequency cells in SIB1 (e.g., not intraFreqReselection in MIB). In some aspects, the TN UEs that do not support NTN may assume that intra frequency reselection is not allowed.

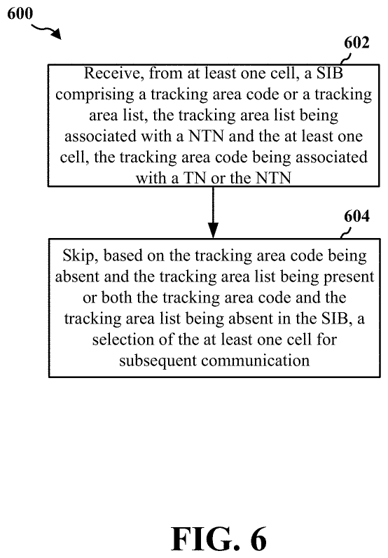

FIG. 6 is a flowchart 600 of a method of wireless communication. The method may be performed by a UE (e.g., the UE 104; the apparatus 904), such as a TN UE or an NTN UE.

At 602, the UE may receive, from at least one cell, a system information block (SIB) including a tracking area code or a tracking area list, the tracking area list being associated with a non-terrestrial network (NTN) and the at least one cell, the tracking area code being associated with a terrestrial network (TN) or the NTN. In some aspects, 602 may be performed by cell selection component 198. In some aspects, a supported network of the UE corresponds to the TN. In some aspects, the supported network of the UE corresponds to the NTN and the SIB does not include the tracking area list. In some aspects, the tracking area code may be associated with a network type of the at least one cell. In some aspects, the tracking area code may be associated with a physical location area associated with the at least one cell. In some aspects, the tracking area list may be associated with a network type of the at least one cell. In some aspects, the tracking area list may be associated with a physical location area associated with the at least one cell. In some aspects, the UE may be barred from selecting the at least one cell for the subsequent communication for a time period and the UE may select the at least one cell for the subsequent communication after the time period. In some aspects, the UE may be barred from selecting the at least one cell for the subsequent communication for a duration of the UE storing first information about barring access to the at least one cell, and the first information about barring the access to the at least one cell may include at least one of a physical cell identifier (PCID) or a frequency of the at least one cell. In some aspects, the UE may perform cell reselection for one or more other cells on a same frequency of the at least one cell. In some aspects, the UE may perform cell reselection at least based on indication provided in Master Information Block (MIB). In some aspects, the UE may perform cell reselection at least based on indication provided in SIB1, the SIB1 being the SIB.

At 604, the UE may skip, based on the tracking area code being absent and the tracking area list being present or both the tracking area code and the tracking area list being absent in the SIB, a selection of the at least one cell for subsequent communication. In some aspects, 604 may be performed by cell selection component 198. For example, an NTN UE may skip a selection of the at least one cell for subsequent communication based on the tracking area list not being in the SIB. A TN UE may skip a selection of the at least one cell for subsequent communication based on the tracking area code not being in the SIB.

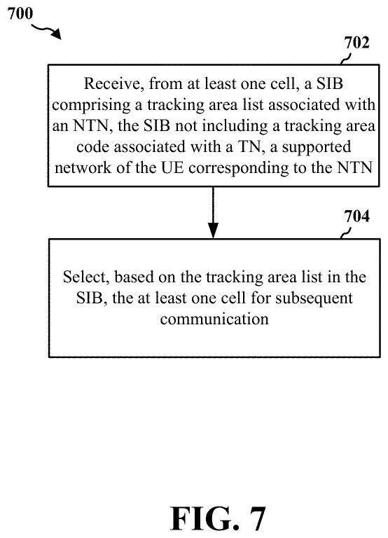

FIG. 7 is a flowchart 700 of a method of wireless communication. The method may be performed by a UE (e.g., the UE 104; the apparatus 904).

At 702, the UE may receive, from at least one cell, a SIB including a tracking area list associated with an NTN, the SIB not including a tracking area code associated with a TN, a supported network of the UE corresponding to the NTN. In some aspects, 702 may be performed by cell selection component 198. In some aspects, 702 may be performed by cell selection component 198. In some aspects, the tracking area code may be associated with a network type of the at least one cell. In some aspects, the tracking area code may be associated with a physical location area associated with the at least one cell. In some aspects, the tracking area list may be associated with a network type of the at least one cell. In some aspects, the tracking area list may be associated with a physical location area associated with the at least one cell.

At 704, the UE may select, based on the tracking area list in the SIB, the at least one cell for subsequent communication. In some aspects, 704 may be performed by cell component 199. In some aspects, 704 may be performed by cell selection component 198.

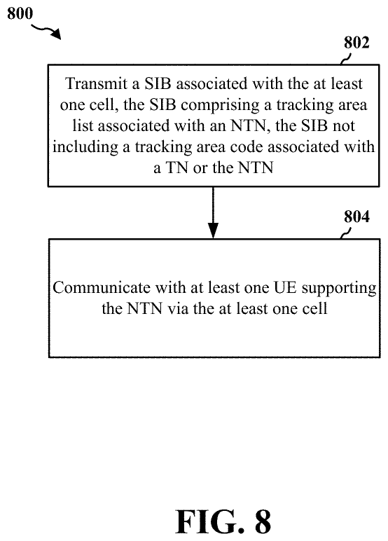

FIG. 8 is a flowchart 800 of a method of wireless communication. The method may be performed by a network entity (e.g., the base station 102/180; the network entity 902).

At 802, the network entity may transmit a SIB associated with the at least one cell, the SIB including a tracking area list associated with an NTN, the SIB not including a tracking area code associated with a TN. In some aspects, 802 may be performed by cell component 199. In some aspects, the tracking area code may be associated with a network type of the at least one cell. In some aspects, the tracking area code may be associated with a physical location area associated with the at least one cell. In some aspects, the tracking area list may be associated with a network type of the at least one cell. In some aspects, the tracking area list may be associated with a physical location area associated with the at least one cell.

At 804, the network entity may communicate with at least one UE supporting the NTN via the at least one cell. In some aspects, 804 may be performed by cell component 199.

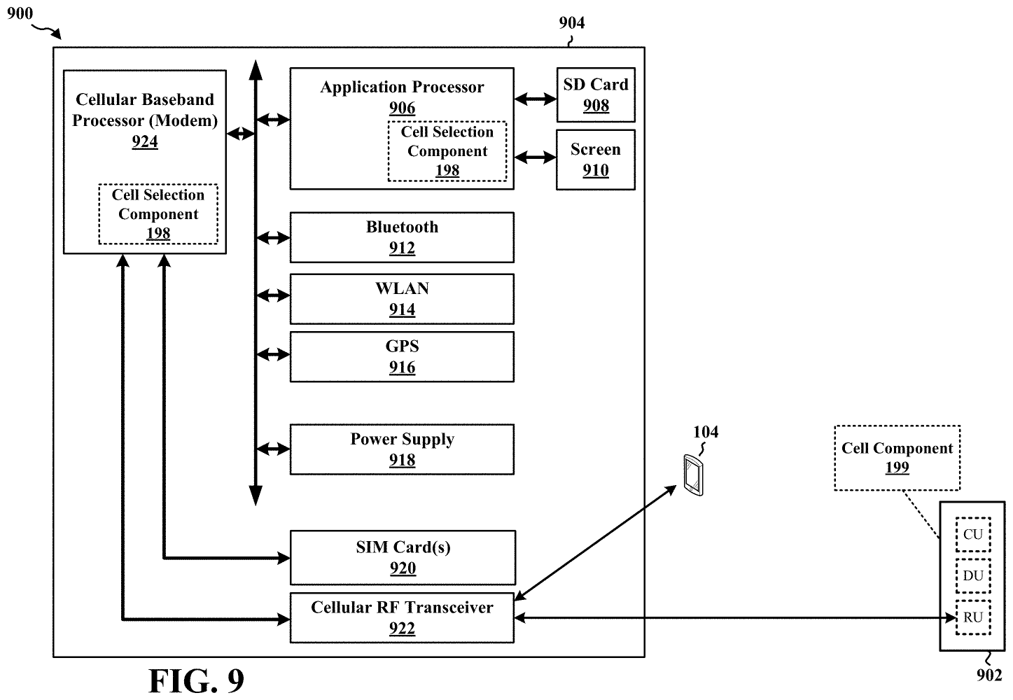

FIG. 9 is a diagram 900 illustrating an example of a hardware implementation for an apparatus 904 and a network entity 902. The apparatus 904 may be a UE, a component of a UE, or may implement UE functionality. The network entity 902 may be a B S, a component of a BS, or may implement BS functionality. In some aspects, the apparatus 904 may include a cellular baseband processor 924 (also referred to as a modem) coupled to a cellular RF transceiver 922. In some aspects, the apparatus 904 may further include one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, or a power supply 918. The cellular baseband processor 924 communicates through the cellular RF transceiver 922 with the UE 104 and/or with an RU associated with the network entity 902. The RU is either part of the network entity 902 or is in communication with the network entity 902. The network entity 902 may include one or more of the CU, DU, and the RU. The cellular baseband processor 924 and the application processor 906 may each include a computer-readable medium/memory. Each computer-readable medium/memory may be non-transitory. The cellular baseband processor 924 and the application processor 906 are each responsible for general processing, including the execution of software stored on the computer-readable medium/memory. The software, when executed by the cellular baseband processor 924/application processor 906, causes the cellular baseband processor 924/application processor 906 to perform the various functions described supra. The computer-readable medium/memory may also be used for storing data that is manipulated by the cellular baseband processor 924/application processor 906 when executing software. The cellular baseband processor 924/application processor 906 may be a component of the UE 350 and may include the memory 360 and/or at least one of the TX processor 368, the RX processor 356, and the controller/processor 359. In one configuration, the apparatus 904 may be a processor chip (modem and/or application) and include just the cellular baseband processor 924 and/or the application processor 906, and in another configuration, the apparatus 904 may be the entire UE (e.g., see 350 of FIG. 3) and include the additional modules of the apparatus 904.

As discussed supra, the cell selection component 198 may be configured to receive, from at least one cell, a system information block (SIB) including a tracking area code or a tracking area list, the tracking area list being associated with a non-terrestrial network (NTN) and the at least one cell, the tracking area code being associated with a terrestrial network (TN) or the NTN. In some aspects, the cell selection component 198 may be further configured to skip, based on the tracking area code being absent and the tracking area list being present or both the tracking area code and the tracking area list being absent, a selection of the at least one cell for subsequent communication. In some aspects, the cell selection component 198 may be configured to receive, from at least one cell, a system information block (SIB) including a tracking area list associated with a non-terrestrial network (NTN) and the at least one cell, the SIB not including a tracking area code associated with a terrestrial network (TN) or the NTN, a supported network of the UE corresponding to the NTN. In some aspects, the cell selection component 198 may be further configured to select, based on the tracking area list in the SIB, the at least one cell for subsequent communication. The cell selection component 198 may be within the cellular baseband processor 924, the application processor 906, or both the cellular baseband processor 924 and the application processor 906. The cell selection component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 904 may include a variety of components configured for various functions. In one configuration, the apparatus 904, and in particular the cellular baseband processor 924 and/or the application processor 906, includes means for receiving, from at least one cell, a system information block (SIB) including a tracking area code or a tracking area list, the tracking area list being associated with a non-terrestrial network (NTN) and the at least one cell, the tracking area code being associated with a terrestrial network (TN) or the NTN; means for skipping, based on the tracking area code being absent and the tracking area list being present or both the tracking area code and the tracking area list being absent in the SIB, a selection of the at least one cell for subsequent communication; means for selecting the at least one cell for the subsequent communication after the time period; means for performing cell reselection for one or more other cells on a same frequency of the at least one cell; means for performing cell reselection at least based on indication provided in Master Information Block (MIB); means for performing cell reselection at least based on indication provided in SIB1, the SIB1 being the SIB; means for receiving, from at least one cell, a system information block (SIB) including a tracking area list associated with a non-terrestrial network (NTN) and the at least one cell, the SIB not including a tracking area code associated with a terrestrial network (TN) or the NTN, a supported network of the UE corresponding to the NTN; or means for selecting, based on the tracking area list in the SIB, the at least one cell for subsequent communication. The means may be the component 198 of the apparatus 904 configured to perform the functions recited by the means. As described supra, the apparatus 904 may include the TX processor 368, the RX processor 356, and the controller/processor 359. As such, in one configuration, the means may be the TX processor 368, the RX processor 356, and/or the controller/processor 359 configured to perform the functions recited by the means.

As discussed supra, the cell component 199 may be configured to transmit a system information block (SIB) associated with the at least one cell, the SIB including a tracking area list associated with a non-terrestrial network (NTN) and the at least one cell, the SIB not including a tracking area code associated with a terrestrial network (TN) or the NTN. In some aspects, the cell component 199 may be further configured to communicate with at least one UE supporting the NTN via the at least one cell.

The cell component 199 may be within one or more processors (e.g., BBU(s)) of one or more of the CU, DU, and the RU. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 902 may include a variety of components configured for various functions. In one configuration, the network entity 902 includes means for transmitting a system information block (SIB) associated with the at least one cell, the SIB including a tracking area list associated with a non-terrestrial network (NTN) and the at least one cell, the SIB not including a tracking area code associated with a terrestrial network (TN) or the NTN; or means for communicating with at least one UE supporting the NTN via the at least one cell. The means may be the cell component 199 of the network entity 902 configured to perform the functions recited by the means. As described supra, the network entity 902 may include the TX processor 316, the RX processor 370, and the controller/processor 375. As such, in one configuration, the means may be the TX processor 316, the RX processor 370, and/or the controller/processor 375 configured to perform the functions recited by the means.

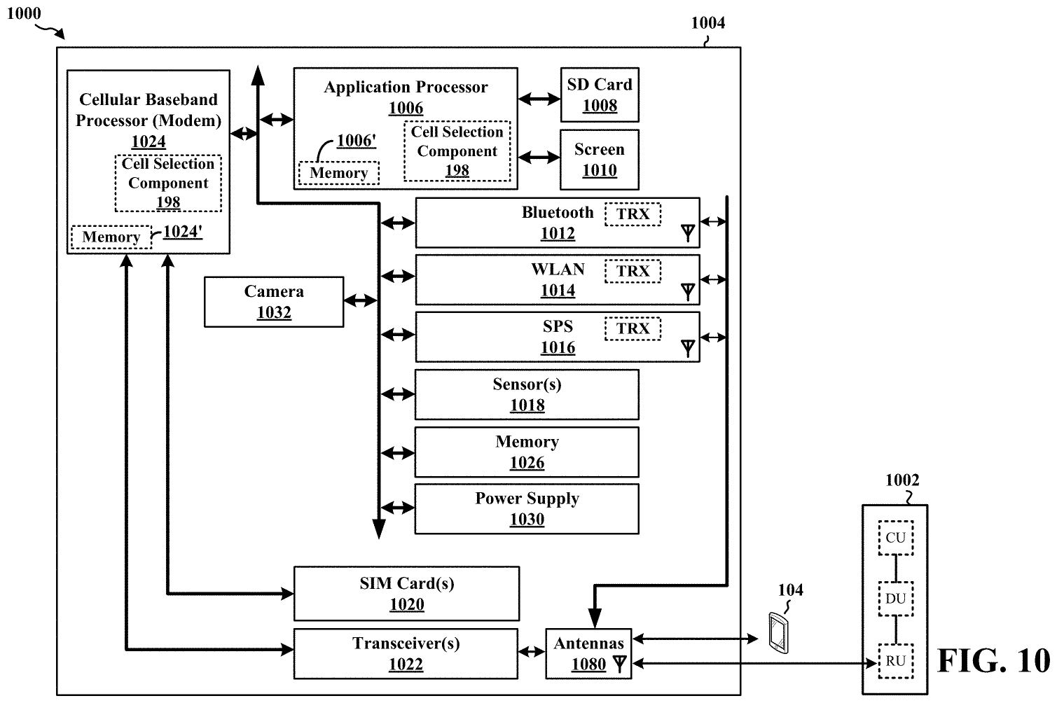

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, a satellite system module 1016 (e.g., GNSS module), one or more sensor modules 1018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the satellite system module 1016 may include an on-chip transceiver (TRX)/receiver (RX). The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described herein. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

In some aspects, the cell selection component 198 may be configured to receive, from at least one cell, a system information block (SIB) including a tracking area code or a tracking area list, the tracking area list being associated with a non-terrestrial network (NTN) and the at least one cell, the tracking area code being associated with a terrestrial network (TN) or the NTN. In some aspects, the cell selection component 198 may be further configured to skip, based on the tracking area code being absent and the tracking area list being present or both the tracking area code and the tracking area list being absent in the SIB, a selection of the at least one cell for subsequent communication. In some aspects, the cell selection component 198 may be configured to receive, from at least one cell, a system information block (SIB) including a tracking area list associated with a non-terrestrial network (NTN) and the at least one cell, the SIB not including a tracking area code associated with a terrestrial network (TN) or the NTN, a supported network of the UE corresponding to the NTN. In some aspects, the cell selection component 198 may be further configured to select, based on the tracking area list in the SIB, the at least one cell for subsequent communication. The cell reselection component 198 may be within the cellular baseband processor 1024, the application processor 1006, or both the cellular baseband processor 1024 and the application processor 1006. The cell reselection component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for receiving, from at least one cell, a system information block (SIB) including a tracking area code or a tracking area list, the tracking area list being associated with a non-terrestrial network (NTN) and the at least one cell, the tracking area code being associated with a terrestrial network (TN) or the NTN; means for skipping, based on the tracking area code being absent and the tracking area list being present or both the tracking area code and the tracking area list being absent in the SIB, a selection of the at least one cell for subsequent communication; means for selecting the at least one cell for the subsequent communication after the time period; means for performing cell reselection for one or more other cells on a same frequency of the at least one cell; means for performing cell reselection at least based on indication provided in Master Information Block (MIB); means for performing cell reselection at least based on indication provided in SIB1, the SIB1 being the SIB; means for receiving, from at least one cell, a system information block (SIB) including a tracking area list associated with a non-terrestrial network (NTN) and the at least one cell, the SIB not including a tracking area code associated with a terrestrial network (TN) or the NTN, a supported network of the UE corresponding to the NTN; or means for selecting, based on the tracking area list in the SIB, the at least one cell for subsequent communication. The means may be the cell reselection component 198 of the apparatus 1004 configured to perform the functions recited by the means. As described herein, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

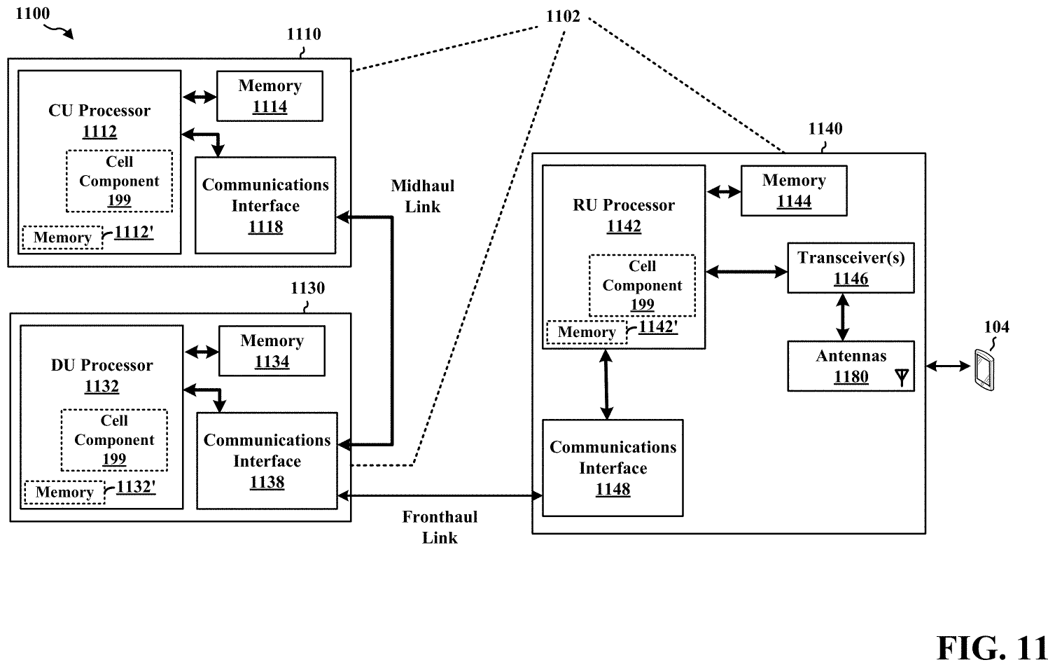

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the cell component 199 may be configured to transmit a system information block (SIB) associated with the at least one cell, the SIB including a tracking area list associated with a non-terrestrial network (NTN) and the at least one cell, the SIB not including a tracking area code associated with a terrestrial network (TN) or the NTN. In some aspects, the cell component 199 may be further configured to communicate with at least one UE supporting the NTN via the at least one cell. The cell component 199 may be within one or more processors of one or more of the CU 1110, DU 1130, and the RU 1140. The cell component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for transmitting a system information block (SIB) associated with the at least one cell, the SIB including a tracking area list associated with a non-terrestrial network (NTN) and the at least one cell, the SIB not including a tracking area code associated with a terrestrial network (TN) or the NTN. In some aspects, the network entity 1102 may further include means for communicating with at least one UE supporting the NTN via the at least one cell. The means may be the cell component 199 of the network entity 1102 configured to perform the functions recited by the means. As described herein, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method for communication at a user equipment (UE), including: receiving, from at least one cell, a system information block (SIB) including a tracking area code or a tracking area list, the tracking area list being associated with a non-terrestrial network (NTN) and the at least one cell, the tracking area code being associated with a terrestrial network (TN) or the NTN; and skipping, based on the tracking area code being absent and the tracking area list being present or both the tracking area code and the tracking area list being absent in the SIB, a selection of the at least one cell for subsequent communication. In some aspects, a supported network of the UE corresponds to the TN. In some aspects, the supported network of the UE corresponds to the NTN and the SIB does not include the tracking area list.

Aspect 2 is the method of aspect 1, where, further including skip, based on an absence of a registered tracking area in the tracking area list in the SIB, the at least one cell for the subsequent communication.

Aspect 3 is the method of any of aspects 1-2, where the tracking area code is associated with a physical location area associated with the at least one cell.

Aspect 4 is the method of any of aspects 1-3, where the tracking area list is associated with a network type of the at least one cell.

Aspect 5 is the method of any of aspects 1-4, where the tracking area list is associated with a physical location area associated with the at least one cell.

Aspect 6 is the method of any of aspects 1-5, where the UE is barred from selecting the at least one cell for the subsequent communication for a time period, and further including: selecting the at least one cell for the subsequent communication after the time period.

Aspect 7 is the method of any of aspects 1-6, where the UE is barred from selecting the at least one cell for the subsequent communication for a duration of the UE storing first information about barring access to the at least one cell, and the first information about barring the access to the at least one cell includes at least one of a physical cell identifier (PCID) or a frequency of the at least one cell.

Aspect 8 is the method of any of aspects 1-7, further including: performing cell reselection for one or more other cells on a same frequency of the at least one cell.

Aspect 9 is the method of any of aspects 1-8, further including: performing cell reselection at least based on indication for cell reselection provided in a master information block (MIB).

Aspect 10 is the method of any of aspects 1-9, further including: performing cell reselection at least based on an indication for cell reselection provided in a SIB type 1 (SIB1), where the SIB1 is the SIB.

Aspect 11 is a method for communication at a user equipment (UE), including: receiving, from at least one cell, a system information block (SIB) including a tracking area list associated with a non-terrestrial network (NTN) and the at least one cell, the SIB not including a tracking area code associated with a terrestrial network (TN) or the NTN, a supported network of the UE corresponding to the NTN; and selecting, based on the tracking area list in the SIB, the at least one cell for subsequent communication.

Aspect 12 is the method of aspect 11, where the tracking area code is associated with a network type of the at least one cell.

Aspect 13 is the method of any of aspects 11-12, where the tracking area code is associated with a physical location area associated with the at least one cell.

Aspect 14 is the method of any of aspects 11-13, where the tracking area list is associated with a network type of the at least one cell.

Aspect 15 is the method of any of aspects 11-14, where the tracking area list is associated with a physical location area associated with the at least one cell.

Aspect 16 is a method for communication at a network entity associated with at least one cell, including: transmitting a system information block (SIB) associated with the at least one cell, the SIB including a tracking area list associated with a non-terrestrial network (NTN) and the at least one cell, the SIB not including a tracking area code associated with a terrestrial network (TN) or the NTN; and communicating with at least one UE supporting the NTN via the at least one cell.

Aspect 17 is the method of aspect 16, where the tracking area code is associated with a network type of the at least one cell.

Aspect 18 is the method of any of aspects 16-17, where the tracking area code is associated with a physical location area associated with the at least one cell.

Aspect 19 is the method of any of aspects 16-18, where the tracking area list is associated with a network type of the at least one cell.

Aspect 20 is the method of any of aspects 16-19, where the tracking area list is associated with a physical location area associated with the at least one cell.

Aspect 21 is an apparatus for wireless communication at a UE including a memory and at least one processor coupled to the memory and, based at least in part on information stored in the memory, the at least one processor is configured to perform a method in accordance with any of aspects 1-10. The apparatus may include at least one of a transceiver or an antenna coupled to the at least one processor.

Aspect 22 is an apparatus for wireless communications, including means for performing a method in accordance with any of aspects 1-10.

Aspect 23 is a computer-readable medium (e.g., a non-transitory computer-readable medium) including instructions that, when executed by an apparatus, cause the apparatus to perform a method in accordance with any of aspects 1-10.

Aspect 24 is an apparatus for wireless communication at a UE including a memory and at least one processor coupled to the memory and, based at least in part on information stored in the memory, the at least one processor is configured to perform a method in accordance with any of aspects 11-15. The apparatus may include at least one of a transceiver or an antenna coupled to the at least one processor.

Aspect 25 is an apparatus for wireless communications, including means for performing a method in accordance with any of aspects 11-15.

Aspect 26 is a computer-readable medium (e.g., a non-transitory computer-readable medium) including instructions that, when executed by an apparatus, cause the apparatus to perform a method in accordance with any of aspects 11-15.

Aspect 27 is an apparatus for wireless communication at a network entity including a memory and at least one processor coupled to the memory and, based at least in part on information stored in the memory, the at least one processor is configured to perform a method in accordance with any of aspects 16-20. The apparatus may include at least one of a transceiver or an antenna coupled to the at least one processor.

Aspect 28 is an apparatus for wireless communications, including means for performing a method in accordance with any of aspects 16-20.

Aspect 29 is a computer-readable medium (e.g., a non-transitory computer-readable medium) including instructions that, when executed by an apparatus, cause the apparatus to perform a method in accordance with any of aspects 16-20.

What is claimed is:

1. An apparatus for communication at a user equipment (UE), comprising:
a memory; and
at least one processor coupled to the memory and, based at least in part on information stored in the memory, the at least one processor is configured to:
receive, from at least one cell, a system information block (SIB) comprising a tracking area code or a tracking area list, the tracking area list being associated with a non-terrestrial network (NTN) and the at least one cell, the tracking area code being associated with a terrestrial network (TN) or the NTN; and
skip, based on the tracking area code being absent and the tracking area list being present or both the tracking area code and the tracking area list being absent in the SIB, a selection of the at least one cell for subsequent communication.

2. The apparatus of claim 1, wherein the UE is barred from selecting the at least one cell for the subsequent communication for a time period, and wherein the at least one processor is further configured to:
select the at least one cell for the subsequent communication after the time period.

3. The apparatus of claim 1, wherein the UE is barred from selecting the at least one cell for the subsequent communication for a duration of the UE storing first information about barring access to the at least one cell, and the first information about barring the access to the at least one cell comprises at least one of a physical cell identifier (PCID) or a frequency of the at least one cell.

4. The apparatus of claim 1, wherein the at least one processor is further configured to:
perform cell reselection for one or more other cells on a same frequency of the at least one cell.

5. The apparatus of claim 1, wherein the at least one processor is further configured to:
perform cell reselection at least based on an indication for cell reselection provided in a master information block (MIB).

6. The apparatus of claim 1, wherein the at least one processor is further configured to:
perform cell reselection at least based on an indication for cell reselection provided in a SIB type 1 (SIB1), wherein the SIB1 is the SIB.

7. The apparatus of claim 1, wherein the at least one processor is further configured to:
select, based on the tracking area list in the SIB, the at least one cell for the subsequent communication.

8. The apparatus of claim 1, wherein the at least one processor is further configured to:
skip, based on an absence of a registered tracking area in the tracking area list in the SIB, the at least one cell for the subsequent communication.

9. The apparatus of claim 1, wherein a supported network of the UE corresponds to the TN.

10. The apparatus of claim 1, wherein the tracking area code is associated with a network type of the at least one cell.

11. The apparatus of claim 1, wherein the tracking area code is associated with a physical location area associated with the at least one cell.

12. The apparatus of claim 1, wherein the tracking area list is associated with a physical location area associated with the at least one cell.

13. The apparatus of claim 1, further comprising at least one of a transceiver or an antenna coupled to the at least one processor, wherein to receive the SIB, the at least one processor is configured to receive the SIB via at least one of the transceiver or the antenna.

14. An apparatus for communication at a network entity associated with at least one cell, comprising:
memory; and
at least one processor coupled to the memory and, based at least in part on information stored in the memory, the at least one processor is configured to:
transmit a system information block (SIB) associated with the at least one cell, the SIB comprising a tracking area list associated with a non-terrestrial network (NTN) and the at least one cell, the SIB not including a tracking area code associated with a terrestrial network (TN) or the NTN; and
communicate with at least one UE supporting the NTN via the at least one cell.

15. The apparatus of claim 14, wherein the tracking area code is associated with a network type of the at least one cell.

16. The apparatus of claim 14, wherein the tracking area code is associated with a physical location area associated with the at least one cell.

17. The apparatus of claim 14, wherein the tracking area list is associated with a network type of the at least one cell.

18. The apparatus of claim 14, wherein the tracking area list is associated with a physical location area associated with the at least one cell.

19. The apparatus of claim 14, further comprising at least one of a transceiver or an antenna coupled to the at least one processor, wherein to transmit the SIB, the at least one processor is configured to transmit the SIB via at least one of the transceiver or the antenna.

20. A method for communication at a user equipment (UE), comprising:
receiving, from at least one cell, a system information block (SIB) comprising a tracking area list associated with a non-terrestrial network (NTN) and the at least one cell, the SIB not including a tracking area code associated with a terrestrial network (TN) or the NTN, a supported network of the UE corresponding to the TN; and
skipping, based on the tracking area code being absent and the tracking area list being present or both the tracking area code and the tracking area list being absent in the SIB, a selection of the at least one cell for subsequent communication.

21. The method of claim 20, wherein the UE is barred from selecting the at least one cell for the subsequent communication for a duration of the UE storing first information about barring access to the at least one cell, and the first information about barring the access to the at least one cell comprises at least one of a physical cell identifier (PCID) or a frequency of the at least one cell.

22. The method of claim 20, further comprising:
performing cell reselection for one or more other cells on a same frequency of the at least one cell.

23. The method of claim 20, further comprising:
performing cell reselection at least based on an indication for cell reselection provided in a master information block (MIB).

24. The method of claim 20, further comprising:
performing cell reselection at least based on an indication for cell reselection provided in a SIB type 1 (SIB1), wherein the SIB1 is the SIB.

25. The method of claim 20, wherein the tracking area code is associated with a network type of the at least one cell.

26. The method of claim 20, wherein the tracking area code is associated with a physical location area associated with the at least one cell.

27. The method of claim 20, wherein the tracking area list is associated with a network type of the at least one cell.

28. The method of claim 20, wherein the tracking area list is associated with a physical location area associated with the at least one cell.

29. The method of claim 20, wherein the UE is barred from selecting the at least one cell for the subsequent communication for a time period, and further comprising:
selecting the at least one cell for the subsequent communication after the time period.

30. A method for communication performed by a network entity associated with at least one cell, comprising:
transmitting a system information block (SIB) associated with the at least one cell, the SIB comprising a tracking area list associated with a non-terrestrial network (NTN) and the at least one cell, the SIB not including a tracking area code associated with a terrestrial network (TN) or the NTN; and
communicating with at least one UE supporting the NTN via the at least one cell.
